(19) United States
(12) Patent Application Publication
(10) Pub. No.: US 2019/0043297 A1
(43) Pub. Date: Feb. 7, 2019

(54) Door Barricade Lock

(71) Applicant: Deborah A. Smith, McKinney, TX (US)

(72) Inventor: Deborah A. Smith, McKinney, TX (US)

(21) Appl. No.: 16/053,625

(22) Filed: Aug. 2, 2018

Related U.S. Application Data
(60) Provisional application No. 62/540,929, filed on Aug. 3, 2017.

(51) Int. Cl. G07C 9/00; E05C 3/12; E05B 47/00; E05C 19/00

(52) U.S. Cl. CPC G07C 9/00896; E05C 19/005; E05B 47/00; E05C 3/12

(57) ABSTRACT

The automated door-locking device comprises a keypad, a locking bar, and a locking bar catch. The locking bar is of a spring-loaded type. In an embodiment, the automated door-locking device is mounted on a classroom door. The locking bar catch is mounted on the classroom door and the keypad is fastened to the wall of the classroom. The classroom door is allowed to open and close normally when no intruder is on premises. The automated door-locking device is engaged by entering a code using the keypad and setting to “Lock Mode”. The locking bar is automatically rotated to securely engage with the locking bar catch. The automated door-locking device cannot be breached without breaking down the wall or the door. After the threat is over, the user resets the automated door-locking device to the “Safe Mode” using the same code. The locking bar releases from the locking bar catch.

### BACKGROUND OF THE INVENTION

The invention disclosed herein generally relates to door locking devices. More particularly, the invention disclosed herein relates to an automated door-locking device for locking a door of a building.

### DESCRIPTION OF THE PRIOR ART

Typically, door-locking devices function using the electrical power of a building or home. This is disadvantageous to a user as the door-locking device works only when there is power in the grid to which the building is connected. A device, which operates even during a short term or long-term power outage, is required. Furthermore, conventional door protection devices do not withstand large external forces. Typically, when an intruder occurs in a school or office building, the doors are barricaded temporarily with chairs or other furniture. Furniture barricades are not that effective and are overcome by a determined intruder. The doors can be broken into by repeatedly pounding the exterior with heavy materials. A device, which is capable of withstanding large external forces before failing, is required. Moreover, traditional door security devices concentrate only on securing the door. Conventional devices lack a notification system, wherein the device is integrated with security personnel or the local authority. A device, which is easy to install and capable of alerting security personnel or police personnel of a breach, is required.

Hence, there is a long felt but unresolved need for a device, which operates even during a short term or long-term power outage. Furthermore, there is a need for a device, which is capable of withstanding large external forces before failing. Moreover, there is a need for a device, which is easy to install and capable of alerting security personnel or police personnel of a breach.

### SUMMARY OF THE INVENTION

This summary is provided to introduce a selection of concepts in a simplified form that are further disclosed in the detailed description of the invention. This summary is not intended to identify key or essential inventive concepts of the claimed subject matter, nor is it intended for determining the scope of the claimed subject matter.

The automated door-locking device disclosed herein addresses the above-mentioned need for a device, which operates even during a short term or long-term power outage. Furthermore, the automated door-locking device addresses the need for a device, which is capable of withstanding large external forces before failing. Moreover, the automated door-locking device addresses the need for a device, which is easy to install and capable of alerting security personnel or police personnel of a breach. The automated door-locking device disclosed herein comprises a keypad, a locking bar, and a locking bar catch. The locking bar is of a spring-loaded type. In an embodiment, the automated door-locking device is mounted on a classroom door. The locking bar catch is mounted on the classroom door and the keypad is fastened to the wall of the classroom. The classroom door is allowed to open and close normally when no intruder is on premises. The automated door-locking device is engaged by entering a code using the keypad and setting to “Lock Mode”. The locking bar is automatically rotated to securely engage with the locking bar catch. The automated door-locking device cannot be breached without breaking down the wall or the door. After the threat is over, the user resets the automated door-locking device to the “Safe Mode” using the same code. The locking bar releases from the locking bar catch.

### BRIEF DESCRIPTION OF THE DRAWINGS

The foregoing summary, as well as the following detailed description of the invention, is better understood when read in conjunction with the appended drawings. For the purpose of illustrating the invention, exemplary constructions of the invention are shown in the drawings. However, the invention is not limited to the specific methods and structures disclosed herein. The description of a method step or a structure referenced by a numeral in a drawing is applicable to the description of that method step or structure shown by that same numeral in any subsequent drawing herein.

FIG. 1A exemplarily illustrates a front elevation view of an automated door-locking device in lock mode.

FIG. 1B exemplarily illustrates a front elevation view of an automated door-locking device in safe mode.

FIG. 2A exemplarily illustrates a front elevation view of a keypad of an automated door-locking device.

FIG. 2B exemplarily illustrates an exploded view of a keypad of an automated door-locking device.

FIG. 3A exemplarily illustrates a front elevation view of a locking bar catch.

FIG. 3B exemplarily illustrates an exploded view of a locking bar catch.

### DESCRIPTION OF THE PREFERRED EMBODIMENT

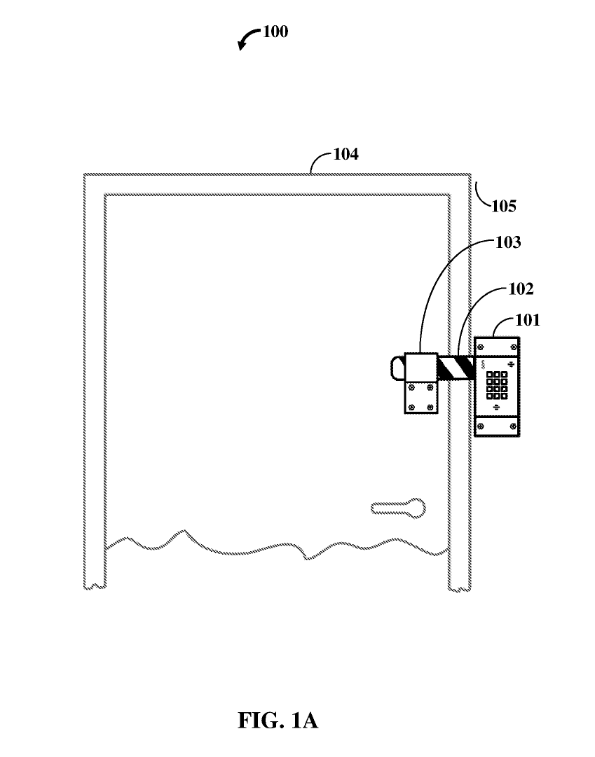

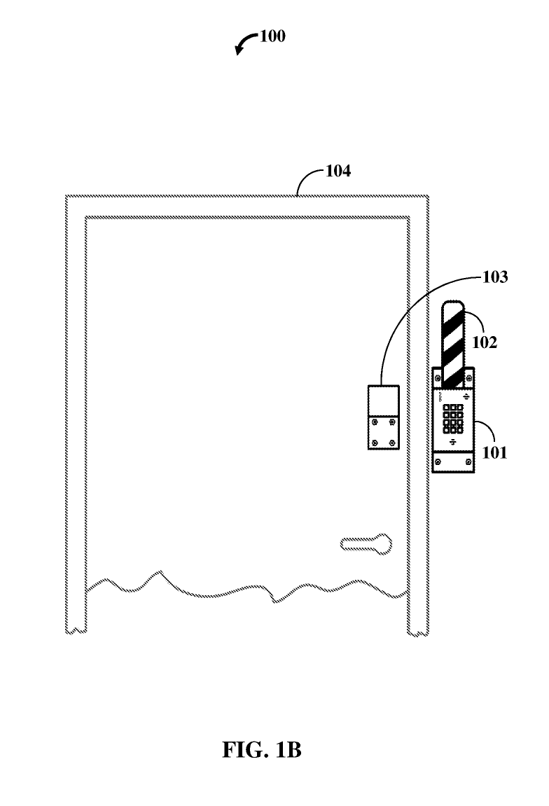

FIG. 1A exemplarily illustrates a front elevation view of an automated door-locking device 100 in “lock mode”. FIG. 1B exemplarily illustrates a front elevation view of an automated door-locking device 100 in safe mode. The automated door-locking device 100 disclosed herein, comprises a keypad 101, a locking bar 102, and a locking bar catch 103. The locking bar 102 is of a spring-loaded type. In an embodiment, the automated door-locking device 100 is mounted on a classroom door 104 as exemplarily illustrated in FIGS. 1A-1B. The locking bar catch 103 is mounted on the classroom door 104 and the keypad 101 is fastened to the wall 105 of the classroom. The classroom door 104 is allowed to open and close normally when no intruder is on premises. The automated door-locking device 100 is engaged by entering a code using the keypad 101 and setting to “Lock Mode”. The locking bar 102 is automatically rotated to securely engage with the locking bar catch 103. The automated door-locking device 100 cannot be breached without breaking down the wall 105 or the door 104. After the threat is over, the user resets the automated door-locking device 100 to the “Safe Mode” using the same code. The locking bar 102 releases from the locking bar catch 103.

In an embodiment, the automated door-locking device 100 is battery-powered. The battery-powered automated door-locking device 100 continues to operate even if the intruder/intruders terminate the power. Upon activation, the proximity system checks to make sure there is no obstruction in the locking bar catch 103. In an embodiment, the automated door-locking device 100 is linked to the school command center via Wi-Fi, or is connected via a hard-wired connection. The hard wiring option is purchased and the appropriate connectivity materials will be supplied with the automated door-locking device 100. The battery is recharged through the building mains using the supplied power cord.

The automated door-locking device 100 provides safety for a home, business, or school, in the event of an attack from an unwanted intruder. The automated door-locking device 100 works by triggering a fortified latching mechanism consisting of a spring-loaded locking bar 101 rotated into a door-mounted holder, when initiated with a code on a keypad 101 by the responsible occupant. When this “Lock Mode” is activated, a fortified mechanical barrier is created which resists forced entry and sounds a siren to alert nearby personnel of the lock down status of the automated door-locking device 100. When installed with the optional communications package the automated door-locking device 100 automatically notifies the authorities of the lock down status and establishes a line of communication between the responsible occupant and the authorities. After the threat from an unwanted intruder is eliminated the responsible occupant re-enters the code into the keypad 101 allowing the user to return the automated door-locking device 100 back to the “Safe Mode” position allowing egress from the room. In an embodiment, the “Safe Mode” is the resting state of the automated door-locking device 100. In an embodiment, the “Lock Mode” is triggered with a code entered into the keypad 101 by the responsible occupant. Once triggered, the spring-loaded locking bar 102 is automatically rotated into the locking bar catch 103 and a siren is automatically activated.

Activation of the automated door-locking device 100 is limited to the responsible occupant. An audible notification, for example, a siren, alarm, etc., notifies nearby persons/personnel of the attack by the intruder. In an embodiment, the keypad 101 is replaced with alternative triggering methods, for example, a removable keypad, magnetic card reader, Radio Frequency Identification (RFID) reader, biometric identifiers including fingerprints, hand geometry, palm vein identification, iris scans, retina scans, face recognition, voice analysis devices, etc.

The automated door-locking device 100 comprises a keypad 101, a locking bar 102, and a locking bar catch 103. The keypad 101 houses LEDs to indicate the operating mode of the automated door-locking device 100 and the siren. Optionally a communications package can be installed that includes a speaker, microphone, and connectivity to a network. In an embodiment, the network connectivity is, for example, wired, wireless, etc. A phone, tablet, or computer app is used by authorities to establish a line of communication. The communications package allows the “reset mode” to be activated remotely by the authorities. Electrical power is obtained from batteries or from being hardwired into the building. In an embodiment, the built-in code keypad 101 is replaced with alternative triggering methods, for example, a removable keypad, a magnetic card reader, a Radio Frequency Identification (RFID) reader, biometric identifiers, fingerprint devices, hand geometry, palm vein identification, iris scans, retina scans, face recognition, voice analysis devices, etc.

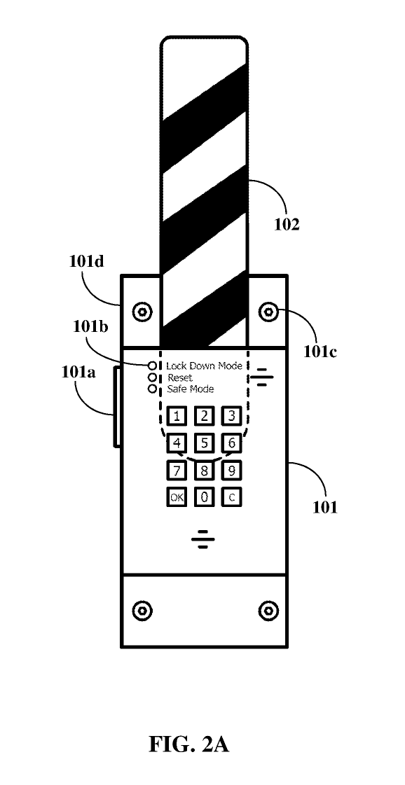

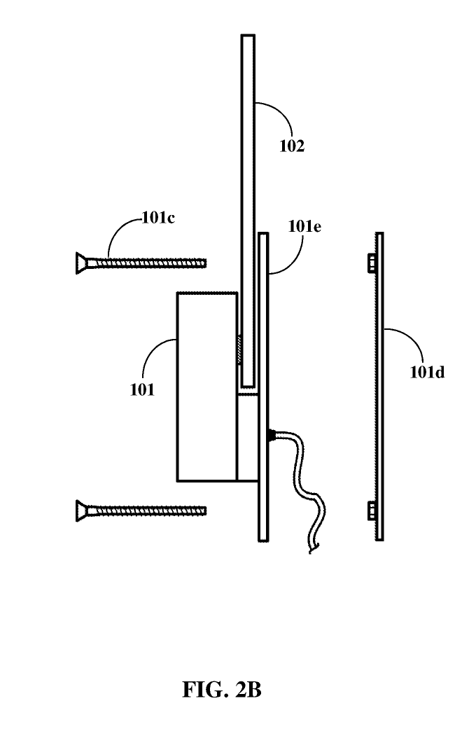

FIG. 2A exemplarily illustrates a front elevation view of a keypad 101 of an automated door-locking device 100. FIG. 2B exemplarily illustrates an exploded view of a keypad 101 of an automated door-locking device 100. The keypad 101 is fabricated using various components. The keypad 101 comprises a proximity sensor 101a, light sources 101b, fasteners 101c, and a mounting panel 101d as exemplarily illustrated in FIGS. 2A-2B. The proximity sensor 101a is positioned on the side of the keypad unit proximal to the locking bar catch 103. The proximity sensor 101a observes the opening of the locking bar catch 103 and notifies the processor about the position of the locking bar 102. The light sources 101b, for example, LEDs, etc., are provided to indicate the current operating mode of the automated door-locking device 100.

In an embodiment, the light sources 101b and the processor are mounted on a printed circuit board (PCB). The PCB for the keypad 101 is fabricated adhering to the final assembler's requirements. The standard thickness, double-sided FR4 circuit board material is populated with surface mounted components where possible. Any through-hole devices are inserted after the surface mounted assembly, soldering, and cleaning. The PCB is designed to have all the components oriented so they can be mounted with the LED illuminators projecting out of the lenses mounted in the housings. After assembly, the PCB is protected with a moisture adsorption preventive conformal coating. In an embodiment, the automated door-locking device 100 is installed securely to both the door 104 and the adjacent wall 105. The keypad 101 is mounted securely to the wall 105 using the mounting panel 101d. The mounting panel 101d is mounted on the opposite side of the wall 105 as the keypad 101.

In an embodiment, the locking bar 102 is cut to shape from 6061 alloy sheet stock using a computer numerically controlled (CNC) water jet machining center, is cleaned and hard anodized. After anodizing, the locking bar 102 is powder painted and striped to meet the purchaser's selection. After painting and thermal cure, the center shaft is pressed into place and secured with a hardened set screw into a slot in the locking bar 102 lower radius. The shaft is part of the robust gear assembly and protrudes out the back of the thick walled electronics box. In an embodiment, the keypad 101, the locking bar 102, and the locking bar catch 103 are supplied in various vibrant colors. A distinctive color is chosen to enhance the recognition factor. In an embodiment, the locking bar 102 is striped to be easily observed from anywhere in the room. In an embodiment, the automated door-locking device 100 uses a 2 GHz microprocessor and various cellular phone components to operate. A large Li-Ion battery is included with a smart charger to allow the automated door-locking device 100 to operate for a minimum of 8 hours without external power. This includes up to two “lock mode” activations.

The DC motor and gear assembly fit into the specially cast electronics box with the 0.5-inch thick back wall. The 1.0-inch diameter shaft is cast as an integral part of the gear. The commercially available, compact DC motor is bi-directional and moves the shaft and the locking bar 102 90° into the locking of safe positions under computer control. The spacer block 101e and the mounting panel 101d are assembled, after the locking bar 102 is installed, using high-energy adhesive and 0.25-inch diameter flathead screws. The spacer block 101e is fabricated from the appropriate thickness of aluminum sheet, cut to shape on the water jet-machining center, cleaned, and then hard anodized.

The keypad 101 controls the locking bar 102 deployment and retraction. The light sources 101b indicate the operating mode of the automated door-locking device 100. The proximity sensor 101a observes the opening of the locking bar catch 103. The solid aluminum locking bar 102 is deployed with a robust gear drive and will withstand over 1,000 pounds of impact repeatedly. The mounting panel 101d is located on the outer wall 105 and uses the strength of the wall 105 to secure the interior components. In an embodiment, the smooth outer surface of the mounting panel 101d is painted, for example, in the color of the wall 105, covered with a sign or poster, disguising it. The automated door locking-device 100 is secured to the wall 105 using fasteners 101c, for example, four 3/8-16 screws.

The front plate is injection molded from a plastic material, for example, polycarbonate/ABS plastic, etc. After molding, the commercially available keypad 101 is installed with the LEDS, the speaker/microphone, the specially designed electronics, and the ultrasonic buzzer. This front plate is mounted on the thick back plate box, the spacer block 101e, and the mounting panel 101d, which make up the keypad 101. In use, the instructor keys in their assigned code and the proximity sensor 101a observes if the locking bar catch 103 area is unobstructed. If it is unobstructed, the DC motor drives the robust gear assembly and quickly rotates the locking bar 102 90° into position. The automated door-locking device 100 communicates via WI-FI that the automated door-locking device 100 is in “Lock Mode”. The automated door-locking device 100 turns on the appropriate light source 101b, for example, LED, etc., and buzzer. If a voice message comes in from the command center, the buzzer is shut off for the duration of the conversation. Depressing the OK button on the keypad 101 allows the instructor to talk to the command center.

After the danger is cleared, the instructor enters their code and presses the clear button. The RESET LED comes on and 5 seconds later, the locking bar 102 rotates back to the stored position, whereupon the “Safe Mode” LED comes on and remains lighted as long as there is charge in the battery. Furthermore, in an embodiment, all doors in the school or office can be locked at once via Wi-Fi or hard wired connection from the command center. Using this feature, the “Reset/Safe Mode” is executed from the command center. The mounting panel 101d is cut to shape from 0.25-inch thick aluminum plate on the water jet-machining center, cleaned, and hard anodized. The keypad 101 is fastened to the wall 105 using the fasteners 101c. The fasteners 101c used are, for example, commercially available stainless steel 3/8-16 flathead screws sized to fit common school, home and office doors for the locking bar catch 103. The fasteners 101c are sized to fit through the wall 105 and hold the mounting panel 101d on securely, far exceeding the 1,000-pound load specification. The user must measure the door 104 and wall 105 thickness at the mounting location. This information is used to procure the optimum screw length for the installation.

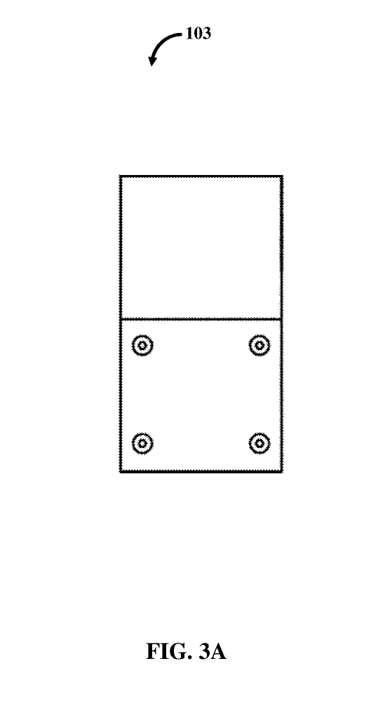

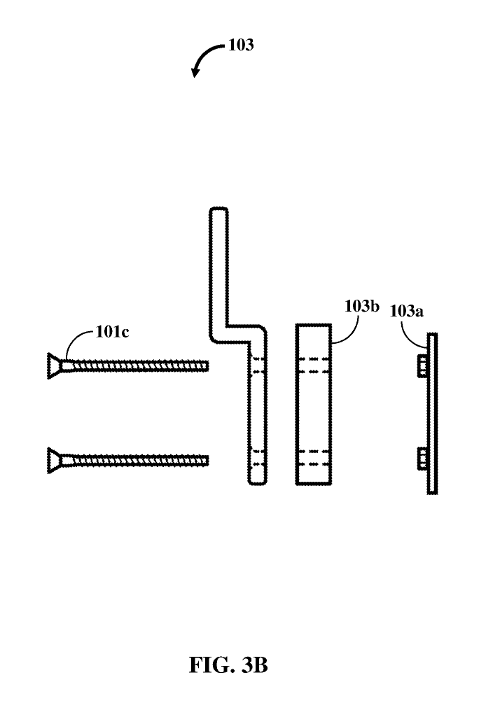

FIG. 3A exemplarily illustrates a front elevation view of a locking bar catch 103. FIG. 3B exemplarily illustrates an exploded view of a locking bar catch 103. In an embodiment, the locking bar catch 103 is fabricated from 6061 aluminum alloy sheet. The 0.5-inch sheet stock is cut to shape using a computer numerically controlled (CNC) water jet machining center. After fabrication, the milled part is subjected to special die in back flywheel press, which forms the offset part. After stamping, the locking bar catch 103 is hard anodized and made ready for powder painting. The spacer is cut to shape from the appropriate thickness of aluminum sheet, cut to shape on the water jet-machining center, cleaned, and then hard anodized. The door mounting plate 103a is cut to shape from 0.25-inch thick aluminum plate, cleaned, and hard anodized. The door mounting plate 103a are fastened to the door 104 using fasteners 101c, for example, four swage nuts. In an embodiment, the locking bar catch 103 is made from stamped aluminum sheet and is secured to the interior door face. The locking bar catch 103 accepts the locking bar 102 from the other module and snugly holds it until reset. The 0.5-inch thick aluminum locking bar catch 103 is secured to the door 104 using fasteners 101c, for example, four 3/8-16 screws. The hallway side of the door 104 uses a 0.25-inch thick plate to hold the interior spacer 103b and locking bar catch 103 in place so it also can withstand up to 1,000 pounds of impact without degradation.

The door mounting plate 103a can be made larger to spread the impact over a larger surface, mitigating the impact intensity per square inch.

The foregoing examples have been provided merely for the purpose of explanation and are in no way to be construed as limiting of the automated door-locking device 100, disclosed herein. While the automated door-locking device 100 has been described with reference to various embodiments, it is understood that the words, which have been used herein, are words of description and illustration, rather than words of limitation. Further, although the automated door-locking device 100 has been described herein with reference to particular means, materials, and embodiments, the automated door-locking device 100 is not intended to be limited to the particulars disclosed herein; rather, the automated door-locking device 100 extends to all functionally equivalent structures, methods and uses, such as are within the scope of the invention. Although there has been shown and described the preferred embodiment of the present invention, it will be readily apparent to those skilled in the art that modifications may be made thereto which do not exceed the scope of the invention.

1) An automated door-locking device for a door of a classroom, comprises:
a keypad mounted on a wall of the classroom,
a locking bar mounted on the door of the classroom being responsive to the keypad, and
a locking bar catch mounted on the door of the classroom being responsive to the keypad.

2) An automated door-locking device as in claim 1, wherein the locking bar is a spring-loaded type.

3) An automated door-locking device as in claim 1, wherein the classroom door is allowed to open and close normally when the keypad has not been activated.

4) An automated door-locking device as in claim 1, wherein the automated door-locking device is engaged by entering a code using the keypad.

5) An automated door-locking device as in claim 1, wherein the locking bar is automatically rotated to securely engage with the locking bar catch in response to the keypad and is released with the keypad.
